(19) United States
(12) Patent Application Publication
(10) Pub. No.: US 2005/0140521 A1
(43) Pub. Date: Jun. 30, 2005

(54) Method for controlling an electronic device from a distance via a command controller

(75) Inventors: Yen-Tsun Lin, Taichung City (TW); Chieh-Yuan Cheng, Taoyuan City (TW); Chang-Hung Lee, Yuan Lin Hsien (TW)

Correspondence Address: Ladas & Parry, 26 West 61st Street, New York, NY, 10023, US

(73) Assignee: BENQ CORPORATION

(21) Appl. No.: 11/011,909

(22) Filed: Dec. 14, 2004

(30) Foreign Application Priority Data
Dec. 29, 2003 (CN) 200310124286.6

(51) Int. Cl. H04B 10/00

(52) U.S. Cl. 340/825.69; 398/115

(57) ABSTRACT

A method for controlling an electronic device from a distance, the electronic device having a first identifying number corresponding to a set of commands for controlling the electronic device, the electronic device further being connected to a command controller which is connected to a command server via a network. The method includes: (1) storing the set of commands in the command server; (2) transmitting a first command to the command server by the command controller; (3) transmitting a second command corresponding to the first command by the command server to the command controller; and (4) controlling the electronic device by the command controller by the second command.

### FIELD OF THE INVENTION

The present invention relates to a method for controlling an electronic device, more particularly to a method for controlling an electronic device from a distance by means of a command controller via the internet.

### BACKGROUND OF THE INVENTION

The rapid advent of multimedia technology brings lots of improvement to the electronic products with multimedia functions which are widely used in the living rooms of some families. The electronic products include TV sets, DVD players, and audio systems. Generally, each electronic product includes an IR receiver, and is provided with an infrared remote controller. A user can send an infrared signal with a predetermined carrier frequency and a specific coding to the electronic product by pressing a button on the remote controller. A built-in signal decoder in the electronic product decodes the infrared signal such that the electronic product can conduct a task.

The remote controllers in different brands are provided by different suppliers with different coding and different carrier frequency. Since the remote controllers in different brands are produced without a standard that a remote controller for controlling an electronic product in a first brand cannot be used to control the same type electronic products in a second brand. Presently, there is a universal remote controller, which is recorded with a plurality set of command signals for controlling different brand electronic products. In order to control a TV set of a specific brand by using the universal remote control, the model number of the TV set must be inputted into the universal remote controller. Only then, the TV set can be activated by the use of the aforesaid universal remote controller. Loss of or unable to memorize the TV model number may render the universal remote controller useless. There is another type of universal remote controller, namely learning type remote controller, which is not recorded with particular signal commands. The controller records the commands of the original remote controller. With the assistance of the original remote controller such that the- learning remote controller possesses the commands of the original remote control in order to control the assigned TV set. However, it is noted that the learning remote controller has a limited storage space and since there are many types of electronic products of complicated constructions, utility of the learning remote controller is relatively inconvenient.

### SUMMARY OF THE INVENTION

The object of the present invention is to provide a method, for controlling an electronic device from a distance by means of a command controller via the internet.

A method is proposed according to the present invention to control an electronic device from a distance by means of a command controller via the internet. The electronic device has an identifying number corresponding to a set of commands for controlling the electronic device. The electronic device is further communicated with a command server via the network. The method for controlling the electronic device from a distance comprises the steps of: (1) storing a set of commands in the command server; (2) transmitting a first command to the command server by the command controller; (3) transmitting the first command to the command server by the command controller; and (4) selecting a second command corresponding to the first command from the set of commands by the command server and transmitting the second command to the command controller.

The aforesaid electronic device may be a TV set or a DVD player or a multimedia electronic device, such as an audio system. The electronic device is provided with an IR remote controller. A built-in infrared receiver is provided in the respective electronic device so as to receive an IR command with a specific carrier frequency transmitted by the remote controller to perform a task, such as playing a song or adjusting the sound volume or changing the channel in the TV set.

Preferably, the command controller includes an IR receiver for receiving a command transmitted by the IR remote controller. The command controller is adapted to be switched to a learning mode. When the command controller is switched to the learning mode, a learning remote controller is used for conducting a learning operation between the learning remote controller and the command controller such that the learning remote controller possesses the characteristics of the remote controller. The learning remote controller is capable of controlling the respective electronic device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram, illustrating interconnection among a display, electronic devices, and a command controller via the internet for controlling the electronic devices from a distance according to the method of the present invention;

FIG. 2 is a block diagram, illustrating the steps for controlling the electronic devices from a distance according the of the present invention;

FIG. 3 is a block diagram, illustrating the steps how a command sever of the present invention conducts a learning operation with the assistance of a learning remote controller; and

FIG. 4 is a block diagram, illustrating interconnection between a command controller and one electronic device according to the method of the present invention.

### DETAILED DESCRIPTION OF THE PREFERRED EMBODIMENT

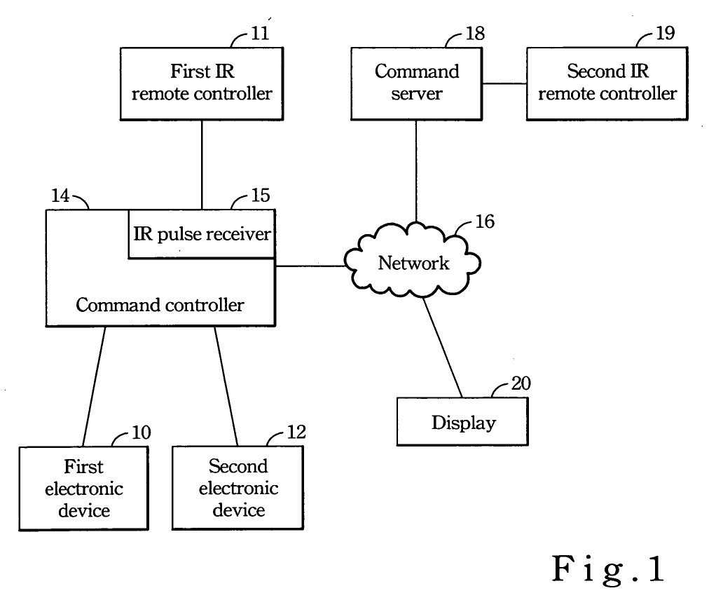

Referring to FIG. 1, an architecture according to the present invention is shown to include a first electronic device 10, a second electronic device 12, a command controller 14, an internet 16, a command server 18 and a display 20.

The first or second electronic device 10, 12 can be a multimedia device, such as a TV set or a DVD player or an audio system. Each electronic device is provided with an IR remote control. Each of the electronic devices 10, 12 is provided with different identifying numbers that corresponds to different sets of commands. Each command may contain different frequency or specific coding for converting to an IR signal to control the respective electronic device. The first electronic device 10 is provided with a first identifying number and a first IR remote controller 11. The second electronic device 12 is provided with a second identifying number.

The aforesaid electronic devices 10, 12 are in signal communication with the command controller 14 via a wired or wireless network. The command controller 14 can be a wireless access point. The command controller 14 is further communicated with the command server 18 and the display 20 via the network 16. The command server 18 may be a personal computer.

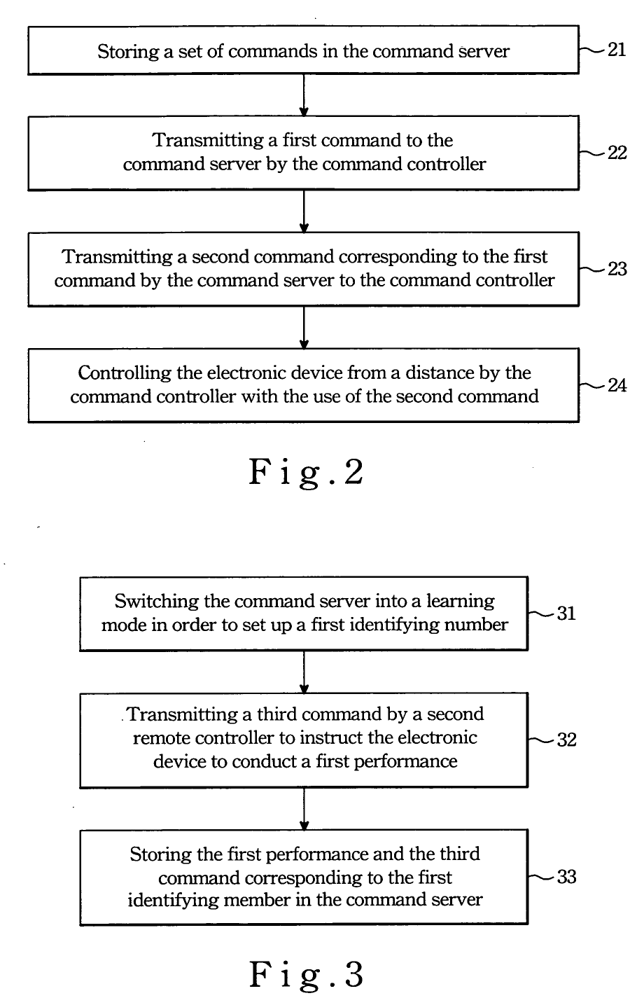

FIG. 2 shows the steps for controlling the first electronic device 10 from a distance according to the present invention and under the architecture of FIG. 1. The steps includes (21) storing the set of commands in the command server 18; (22) transmitting a first command signal to the command server 18 by using the command controller 14, wherein the command server 18 is also stored with a plurality predetermined commands, including the first command signal, in advance. The predetermined commands are corresponding to the set of commands; (23) transmitting a second command signal by the command controller 14 to the command server 18, the second command is corresponding to the first command signal; and finally (24) controlling the first electronic device from a. distance by the command controller 14 by the second command signal.

The command server 18 is preferably in communicating to a specific website via the internet 16 for accessing or downloading the set of first commands corresponding to the first command. When the command controller 14 transmits the first command signal to the command server 18, the command server will transmit a second command signal in response to the first command signal. Under this condition, the user can control the first electronic device 10 from a distance by the second command signal. The command controller 14 obtains the first identifying number when a communication is established between the command controller 14 and the first electronic device 10. Alternatively, the first identifying number is transmitted to the command server 18 by the command controller 14 when a communication is established between the command controller 14 and the first electronic device 10. The first electronic device 10 preferably includes an IR receiver 110 for receiving an IR signal.

In addition, in the step (21), the command server 18 is generally stored with limited commands, such as “open” “play” “adjust sound volume” and “change channels” for the first electronic device 10. In order to enhance the capability of the command server 18, the command server 18 of the present invention can be constructed to have a learning ability.

Referring to FIG. 3, the command server 18 is switched to a learning mode. A second IR remote controller 19 is used for transmitting commands to the command server 18 for command learning. The second IR remote controller 19 may also transmit commands for controlling the first electronic device 10 directly. The command learning method includes: step (31) switching the command server 18 to the learning mode in order to learn commands corresponding to the first identifying number; step (32) transmitting a third command to the command server 18 by the second IR remote controller 19, wherein the first electronic device 10 operates a first function in response to the third command signal; and finally step (33) the first function and the third command signal corresponding to the first identifying number are stored in the command server 18.

From the above description, the command server 18 is provided with the learning ability such that the second IR remote controller 19 can clone and store lots of commands, thereby permitting the command server 18 to control the electronic device from a distance.

The command server 18 of the present invention may also control a second electronic device 12 from a distance. Since the controlling steps are similar to that of the first electronic device 10. An important point to note is that the command server 18 manually selects the first and second identifying numbers when a signal communication is established between the command server 18 and the first electronic devices 10 and the second electronic device 12. Alternatively, the first identifying number is transmitted to the command server 18 by the command controller 14 when the signal communication is established between the command server 18 and the first electronic device 10. Also, the second identifying number is transmitted to the command server 18 by the command controller 14 when the signal communication is established between the command server 18 and the second electronic device 12. The multimedia signal outputted from one of the first and second electronic devices 10,12 is transmitted to a display 20 via the network 16 in order to display an information on the display 20 corresponding to the multimedia signal.

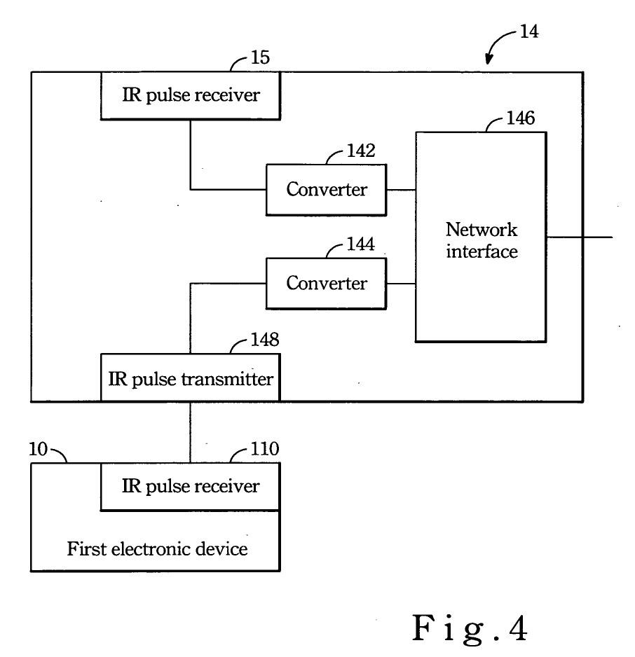

FIG. 4 is a diagram, illustrating interconnection between the command controller 14 and the first electronic device 10. The command controller 14 includes a converter 142 and a network interface device 146. Upon receipt of the IR signal with the carrier frequency and specific coding, the signal converter 142 decodes the IR pulse into digital data, command, which is send to the command server 18 via the network interface device 146. The digital data transmitted by the command server 18 is received by the network interface device 146. The converter 144 converts the digital data and the result is later transmitted to the first electronic device 10 via an IR signal transmitter 148 in order to control the first electronic device 10.

In the above-mentioned preferred embodiment, the command server 18 should not be limited to the personal computer only, it may be a mobile phone or a personal digital assistant so long as to encompass the spirit of the present invention.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A method for controlling a first electronic device from a distance, the first electronic device having a first identifying number corresponding to a set of first commands for controlling the first electronic device, the first electronic device being connected to a command controller, the command controller being connected to a command server through a network, the method comprising:
(a) storing the set of first commands in the command server;
(b) transmitting a first command to the command controller;
(c) transmitting the first command to the command server by the command controller;
(d) selecting a second command corresponding to the first command from the set of first commands by the command server and transmitting the second command to the command controller; and
(e) controlling the first electronic device by the command controller by the second command.

2. The method of claim 1, wherein the command controller comprises an IR receiver for receiving the first command transmitted by a first IR remote control.

3. The method of claim 2, wherein the command server has a learning mode, a second IR remote controller is used for transmitting commands to the command server when the command server is in the learning mode, the second IR remote controller capable of controlling the first electronic device directly, the method further comprising:
setting the command server into the learning mode for setting up commands corresponding to the first identifying number;
transmitting a third command to the command server by the second IR remote controller, the first electronic device operating a first function in response to the third command signal; and
storing the first- function and the third command that correspond to the first identifying number in the command server.

4. The method of claim 1, wherein the command controller communicates with the first electronic device by wireless.

5. The method of claim 4, wherein the command controller is an access point.

6. The method of claim 1, wherein the command controller comprises an IR transmitter for converting the second command into an IR signal.

7. The method of claim 6, wherein the first electronic device comprises an IR receiver for receiving the IR signal.

8. The method of claim 6, wherein the second command includes a carrier frequency and a specific coding of the IR signal.

9. The method of claim 1, wherein the first electronic device is a multimedia player.

10. The method of claim 9, wherein a multimedia signal is outputted from the multimedia player and is further transmitted to a display via the network for displaying the multimedia signal on the display.

11. The method of claim 1, wherein the first identifying number is transmitted to the command server by the command controller when a communication is established between the command controller and the first electronic device.

12 The method of claim 11, wherein the command server obtains the first identifying number by manual.

13. The method of claim 1, wherein a second electronic device connects to the command controller, the second electronic device having a second identifying number, the command server having a set of second command signals that corresponds to the second identifying number.

14. The method of claim 13, wherein the command server selectively determines the first and second identifying numbers by manual operation.

15. The method of claim 13, wherein the first identifying number is transmitted to the command server by the command controller when a communication is established between the command controller and the first electronic device, and the second identifying number is transmitted to the command server by the command controller when a communication is established between the command controller and the second electronic device.

16. The method of claim 13, wherein the command server is connected to a specific website via an Internet for accessing the set of second command signals corresponding to the second identifying number.

17. The method of claim 1, wherein the command server is connected to a specific website via an Internet for accessing the set of first command signals corresponding to the first identifying number.

18. The method of claim 1, wherein the command controller includes an IR receiver and a converter for converting an IR signal into the first command to be received by the IR receiver, the IR signal including an infrared carrier frequency of a specific coding.

19. The method of claim 1, wherein the command server is stored with a plurality sets of predetermined commands which includes the first command and the set of first command signals.
